(19) United States
(12) Patent Application Publication
(10) Pub. No.: US 2004/0215453 A1
(43) Pub. Date: Oct. 28, 2004

(54) Method and apparatus for tailoring an interactive voice response experience based on speech characteristics

(76) Inventor: Julian J. Orbach, Ryde (AU)

Correspondence Address: Bradley M. Knepper, SHERIDAN ROSS P.C, Suite 1200, 1560 Broadway, Denver, CO, 80202-5141, US

(21) Appl. No.: 10/424,183

(22) Filed: Apr. 25, 2003

(51) Int. Cl. G10L 15/00

(52) U.S. Cl. 704/231

(57) ABSTRACT

The present invention is directed to an interactive voice response system that provides responses based on the attributes of a communicant attribute determined from the detected speech characteristics of the communicant. According to the invention, a speech sample from the communicant is obtained and analyzed. Based on the analysis of the speech sample, a communicant attribute is determined, and, a set of voice responses are selected for use in communicating with the communicant.

### FIELD OF THE INVENTION

The present invention is directed to providing an interactive voice response experience that is based on the speech characteristics of a communicant. More particularly, the present invention is directed to providing interactive voice responses that are selected based on the speech characteristics of the communicant.

### BACKGROUND OF THE INVENTION

Interactive voice response systems receive input from a communicant, such as a caller, and provide verbal responses in reply to that input. Interactive voice response systems may include systems that are capable of receiving speech input by a communicant and responding based on the content of that speech. Accordingly, interactive voice response systems can be used to provide information to a communicant aurally or to take instructions from a communicant verbally.

In diverse nations or regions of the world, many people may have a native language that is different from the national or predominant language. Accordingly, even though a call may originate from a particular nation or region, the official or predominant language may not be the preferred language of the caller. In particular, a communicant may feel more comfortable using a language other than the national language of the country from which the call originated. In addition, an interactive voice response system may service calls from different nations or geographic regions, each having their own unique native language, accents, or other speech characteristics.

In order to better meet the needs of communicants, interactive voice response systems have been developed that allow a communicant to select a preferred language for use in communicating with the interactive voice response system. For example, in the United States it is common to offer the user a choice of English or Spanish. However, such systems typically require a user to affirmatively select a preferred language. Accordingly, interactive voice response systems that are capable of automatically tailoring the responses used in communicating with the communicant have not been available. In addition, interactive voice response systems that are tailored to speech characteristics associated with aspects of a caller other than the caller's native language have not been available.

Systems that deliver advertising or entertainment to callers are available. For example, call centers may provide information regarding products or services available from an enterprise associated with the call center to callers waiting for service. However, such systems have not been capable of providing advertising or entertainment that has been determined to be of particular interest to a caller based on the caller's speech characteristics.

### SUMMARY OF THE INVENTION

The present invention is directed to solving these and other problems and disadvantages of the prior art. Generally, according to the invention, a speech sample received from a communicant (for example a caller) is analyzed to determine a speech characteristic. Examples of communicant attributes that can be determined from the communicant's speech characteristics and that can be useful in tailoring other responses provided by an interactive voice response (IVR) system include the communicant's accent, speech speed, native language, gender and age.

After communicant attribute has been determined from a speech characteristic of the communicant, an IVR system in accordance with the present invention may select a set of responses based on the determined speech characteristic. For example, a speech characteristic, such as accent, may be used to identify the communicant's native language. The IVR system may then offer to communicate in the identified language, by using responses from a set of responses in that identified language. If the native language cannot be identified, but the communicant's accent indicates that they are not a native speaker, a response set that includes responses using or including slow speech may be selected. As still another example, speech characteristics that allow the communicant's gender to be identified may be used to select a response set that includes responses in the same (or different) gender as the communicant, and that presents menu options tailored to the determined gender. Where a communicant's speech characteristics can be used to determine the age of the communicant, a response set that includes responses having, for example, an appropriate vocabulary and menu items, can be selected.

The present invention also provides an apparatus for supplying an interactive voice response system having responses tailored to the speech characteristics of a communicant. Such an apparatus may include data storage for storing application programming suitable for performing the method, and stored voice response sets. In addition, the apparatus may include a processor capable of running the application programming, and a communication interface for receiving speech from the communicant and providing responses to the communicant.

### BRIEF DESCRIPTION OF THE DRAWINGS

FIG. 1 is an interactive voice response system interconnected to a communication endpoint in accordance with an embodiment of the present invention;

FIG. 2 is a flow chart depicting the operation of an interactive voice response system in accordance with an embodiment of the present invention;

FIG. 3 is a flow chart depicting additional aspects of the operation of an interactive voice response system in accordance with an embodiment of the present invention; and

FIG. 4 is a flow chart depicting other aspects of the operation of an interactive voice response system in accordance with an embodiment of the present invention.

### DETAILED DESCRIPTION

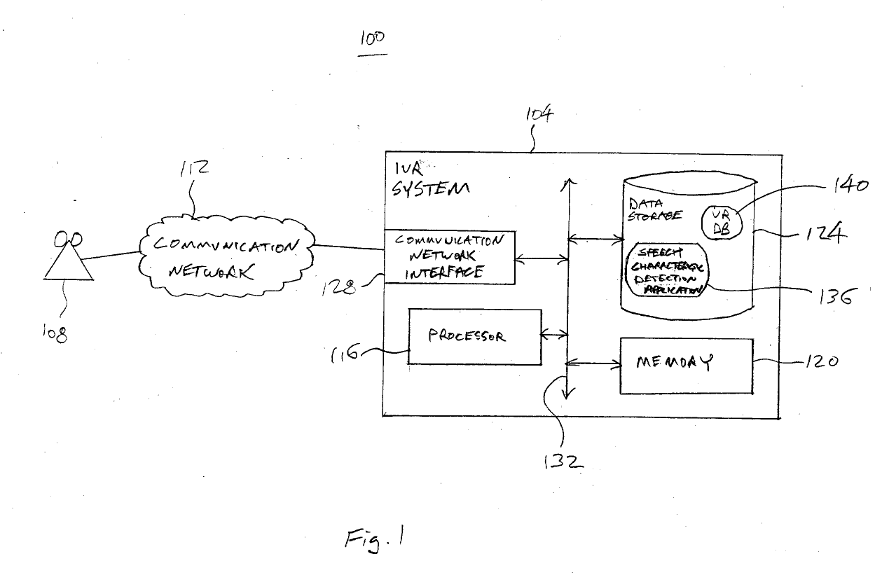

With reference now to FIG. 1, a communication arrangement 100 including an interactive voice response system 104 in accordance an embodiment of the present invention is illustrated. As shown in FIG. 1, the interactive voice response (IVR) system 104 may be interconnected to a communication endpoint 108 by a communication network 112. The interactive voice response system 104 generally includes a processor 116, memory 120, data storage 124, and a communication network interface 128. The various components of the interactive voice response system 104 may be interconnected by an internal communication bus 132. The interactive voice response system 104 may additionally include stored programs and data, including a speech characteristic detection application 136 and a voice response database 140.

As can be appreciated by one of skill in the art, the IVR system 104 may comprise a server computer configured to receive communications from a communicant and provide verbal responses or messages in reply. Accordingly, the IVR system 104 may comprise a call center server. Furthermore, the IVR system 104 may comprise a stored program controlled machine in which the processor 116 executes programs stored in memory 120 or data storage 124 to control the operation of the IVR system 104. In addition, the communication network interface 128 may provide a physical interface between the IVR system 104 and a communicant and/or an administrator.

The communication endpoint 108 is shown interconnected to the IVR system 104 through a communication network 112. In general, the communication endpoint 108 may comprise any device capable of use in connection with realtime communications. For example, the communication endpoint 108 may comprise a telephone or video phone operated by a user (i.e., a communicant). In addition, the communication endpoint 108 may comprise a microphone for input and a speaker for output for use in connection with a communicant that is directly connected to the IVR system 104, for example where the IVR system 104 comprises an automatic teller machine, information kiosk, or other stand-alone device.

The communication network 112 may comprise a switched circuit network, such as the public switch telephone network (PSTN), a packet data network, such as a local area network or a wide area network, including the Internet, or a transmission medium that directly interconnects the communication input 108 to the IVR system 104. Furthermore, it should be appreciated that the communication network 112 may include various combinations of different network types.

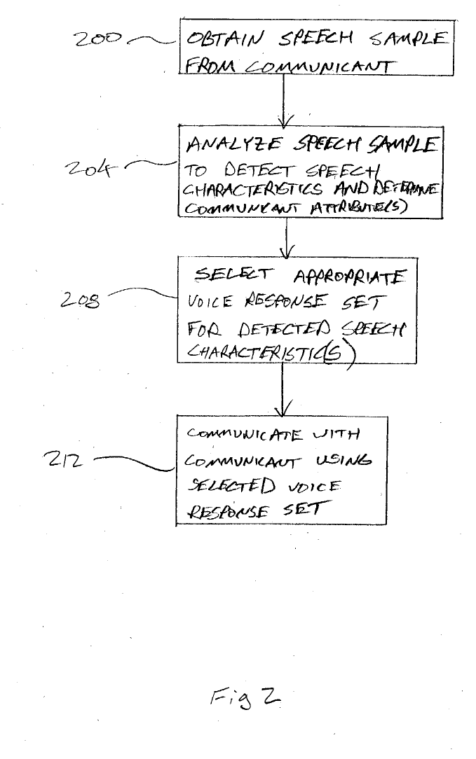

With reference now to FIG. 2, the operation of an IVR system 104 in accordance with an embodiment of the present invention is illustrated. Initially, at step 200, a speech sample is obtained from a communicant. For example, a communicant using a communication endpoint 108 comprising a telephone may initiate a call to a number that is terminated at the IVR system 104. The IVR system 104 may answer the call, and request information from the caller, such as the caller's name and other identifying information, such as an account number. At step 204, the speech sample is analyzed to detect speech characteristics associated with the sample in order to determine a communicant attribute. Speech characteristics that may be detected include, but are not limited to, speech speed, the pronunciation of particular words, the syllables of particular words that are emphasized, voice tone, and choice of words. As used herein, speech characteristics do not include the meaning of words included in the speech sample. Accordingly, the present invention detects as speech characteristics aspects of a speech sample other than a literal or expressed meaning of the speech sample. Communicant attributes that may be determined from detected speech characteristics include the communicant's accent, that the communicant speaks with a foreign or regional accent, speech speed, native language other than the language being used, gender and age.

The detection of speech characteristics may be made using known natural language speech recognition systems trained to recognize speaker traits comprising speech characteristics the detection of which is considered desirable. According to another embodiment of the present invention, the analysis may be performed by comparing the speech sample obtained from the communicant to stored known speech samples. Illustrative techniques for identifying speech characteristics are disclosed in L. M. Arslan, Foreign Accent Classification in American English, Department of Electrical and Computer Engineering Graduate School thesis, Duke University, Durham, N.C., USA (1996), L. M. Arslan et al., “Language Accent Classification in American English”, Duke University, Durham, N.C., USA, Technical Report RSPL-96-7, Speech Communication, Vol. 18(4), pp. 353-367 (June/July 1996), J. H. L. Hansen et al., “Foreign Accent Classification Using Source Generator Based Prosodic Features”, IEEE International Conference or Acoustics, Speech and Signal Processing, 1995, ICASSP-95, Vol. 1, pp. 836-839, Detroit, Mich., USA (May 1995), and L. F. Lamel et al., “Language identification Using Phone-based Acoustic Likelihoods”, IEEE International Conference on Acoustics, Speech, and Signal Processing, 1994, ICASSP-94, Vol. 1, pp. I/293-I/296, Adelaide, SA, AU (19-22 April 1994).

Communicant attributes may be correlated to speech characteristics, allowing the detection of communicant attributes from detected speech characteristics. At step 208, a voice response set that is appropriate for the determined communicant attributes is selected. In general, the voice response sets may be selected that are believed to facilitate communications, and or to provide information that may be of particular relevance to the communicant.

For example, a communicant having a speech characteristic indicating that the communicant speaks English (or whatever natural language is being used) with a foreign accent (i.e., the communicant attribute is speaking English with a foreign accent) might benefit from a voice response set that includes verbal responses comprising speech that is delivered at a slower speed than would normally be used for communications with a native speaker. Similarly, where the communicant's speech characteristics indicate that the communicant's speech patterns are particularly fast or slow (and thus a communicant attribute of speaking fast (or slow) is suggested), a voice response set matching those characteristics may be selected. Where the communicant's speech characteristics indicate that the language being used is not the communicant's native language, and the detected speech characteristics can be used to determine with reasonable certainty the communicant's native language (i.e. the communicant attribute is that the communicant is a native speaker of the determined language), the communicant may be offered the option of interacting with the IVR system 104 using the communicant's native language. Where the detected speech characteristics indicate that the communicant is of a particular gender, the voice response set used may be selected in response to that determination. For example, a voice response set containing verbal responses in a female voice may be provided to a female communicant. It is also possible to determine with some likelihood a communicant attribute comprising the age of a communicant based on the communicant's speech characteristics. Such information may be used to select a voice response set that includes speech patterns or menu selections that are appropriate to the detected age. For example, a voice response set that does not include verbal responses that contain complex grammar, or that involve complex menu selections may be selected if it is determined that the communicant is a child. As still another example, where a communicant's speech characteristics suggest as a communicant attribute a particular emotional disposition, the selection of a voice response set for use in communicating with the communicant may be selected in response to the suggested disposition. For instance, a communicant who is determined to be in a stressed mental state may be provided with verbal responses from a voice response set that contains soothing tones. Furthermore, various combinations of detected speech characteristics may result in the selection of a particular voice response set.

In addition to providing voice responses having speech characteristics that are intended to match or be compatible with the communicant's, a detected speech characteristic of the communicant can be used to determine the content of voice responses appropriate to the communicant. For example, advertising messages or entertainment content provided to a communicant may be selected based on detected speech characteristics of the communicant. Furthermore, menu selections or informational content provided to a communicant may be selected in view of the detected speech characteristics. For instance, as noted above, a communicant whose speech characteristics indicate that the communicant is a child may be provided with age appropriate information using verbal messages delivered using relatively slow speech and relatively simple menu options. Where the detected speech characteristic comprises a particular choice of words, a communicant attribute comprising a level of expertise or knowledge of the communicant regarding a particular subject matter may be determined, and an appropriate voice response set selected in view of the determined attribute.

At step 212, the communicant is communicated with using the selected voice response set. Accordingly, instructions, menu options, information, or responses to inquiries may be provided using verbal responses having selected speech characteristics. Furthermore, the content of the responses is in accordance with the determinations and selections made in response to the analysis of the communicant's speech characteristics.

Although the description of the operation of an IVR system 104 in accordance with the present invention has discussed determining a communicant attribute after detecting a correlated speech characteristic or characteristics, doing so is not necessary to embodiments of the invention. For example, an appropriate response set may be selected directly from a detected speech characteristic. For example, a speech characteristic of slow speech can result in the selection of a voice response set containing verbal responses and/or menu items that use slow speech.

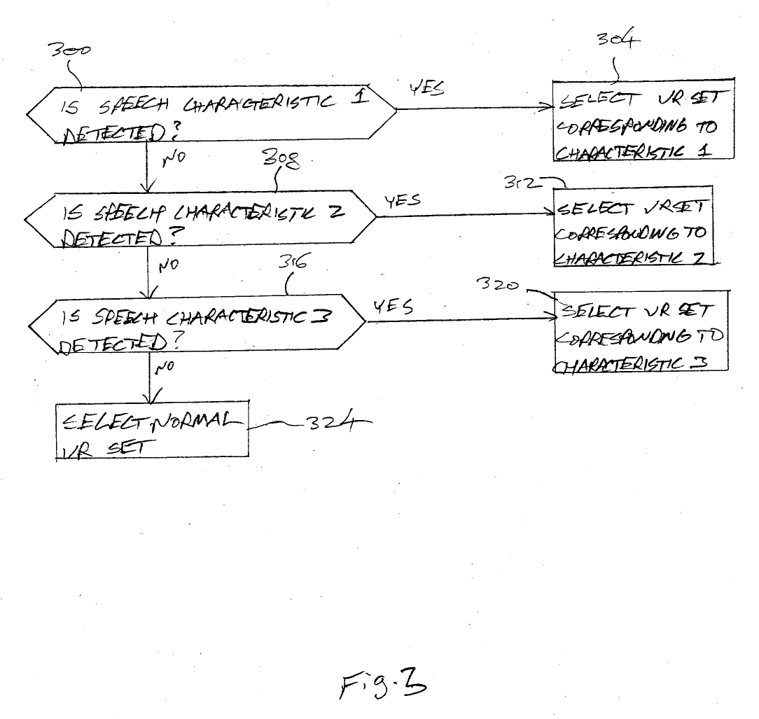

With reference now to FIG. 3, the selection of a voice response set in accordance with an embodiment of the present invention is illustrated. Initially, at step 300, a determination is made as to whether a first speech characteristic is detected. If the first speech characteristic is detected, a voice response set corresponding to the first characteristic is selected (step 304). If this first speech characteristic is not detected, a determination is made as to whether a second speech characteristic is detected (step 308). If the second speech characteristic is detected, a voice response set corresponding to the second characteristic is selected (step 312). If the second speech characteristic is not detected, a determination is made as to whether a third speech characteristic is detected (step 316). If the third speech characteristic is detected, a voice response set corresponding to the third characteristic is selected (step 320). If a third speech characteristic is not detected, a normal voice response set may be selected (step 324). As can be appreciated, the use of three different speech characteristics and corresponding voice response sets is described for illustrative purposes only. In particular, it should be appreciated that any number of characteristics may be monitored. Furthermore, it should be appreciated that the steps illustrated in FIG. 3 describe a hierarchical selection scheme. However, schemes of greater complexity are equally applicable. For instance, determination schemes that weigh various detected speech characteristics (or that weigh communicant attributes determined from detected speech characteristics) may be used to select a particular voice response set from the available voice response sets. Accordingly, various other approaches can be used to select an appropriate voice response set.

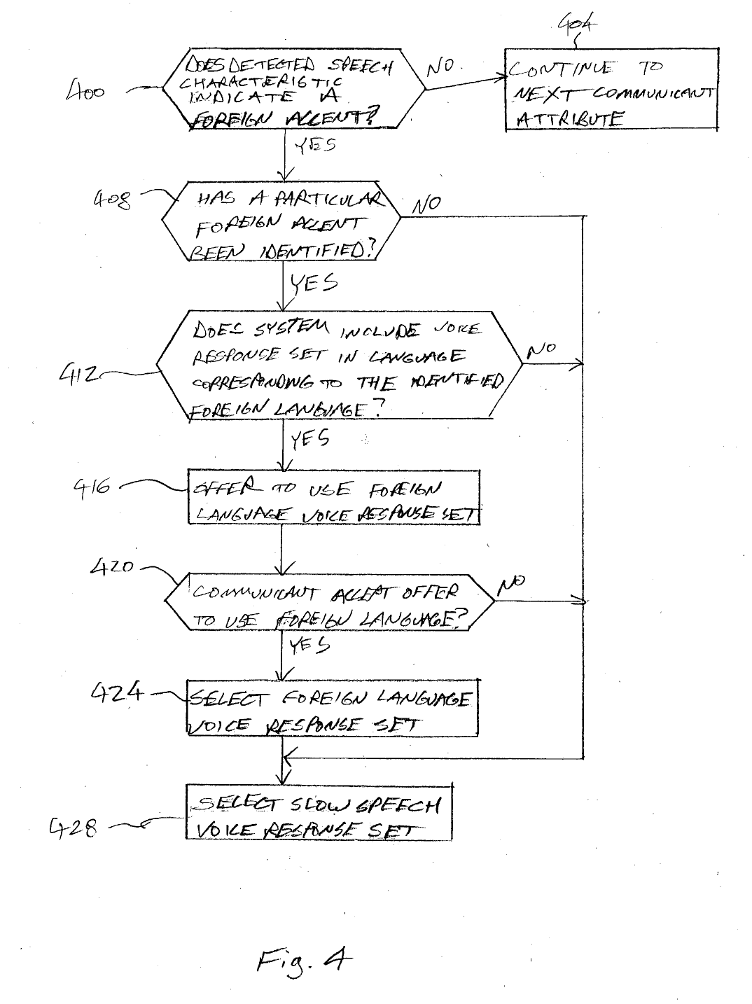

With reference now to FIG. 4, a flow chart depicting the selection of a voice response set in accordance with the identification of a particular speech characteristic at step 204 as illustrated. Initially, at step 400, a determination is made as to whether the detected speech characteristic indicates (as a communicant attribute) that the communicant speaks with a foreign accent. If the determined communicant attribute is not a foreign accent, the system may continue to determine whether the speech characteristic corresponds to a next communicant attribute (step 404). If the detected speech characteristic indicates that communicant speaks with a foreign accent, a determination is next made as to whether a particular foreign accent has been identified (step 408). If a particular foreign accent has been identified, a determination is then made as to whether the IVR system 104 includes a voice response set having responses in a language corresponding to the identified foreign language (step 412). If a voice response set in the language corresponding to the communicant's identified language is available, the IVR system 104 can offer to use the foreign language voice response set in communicating with the communicant (step 416). At step 420, a determination is made as to whether the communicant has accepted the offer to use the identified foreign language (step 420). If the communicant has accepted the offer, the voice response set having responses in the identified foreign language is selected (step 424). If the communicant does not accept the offer to use the identified foreign language (step 420), if the system does not include a voice response set having responses in the identified foreign language (step 412), or if a particular foreign accent has not been identified (step 408), a slow speech voice response set can be selected (step 428).

Of course various changes and modifications to the illustrative embodiments described above will be apparent to those skilled in the art. For example, the communicant may be offered a number of voice response sets having different content and/or speech characteristics to address different communicant attributes. Furthermore, the sets provided to the communicant for potential selection may themselves be selected based on the analyzed speech characteristics of the communicant. In addition, the present invention is not limited to IVR systems that are deployed as part of a call center or communication switch interconnected to a communication network. For example, the present invention may be utilized in stand-alone systems, such as automated information delivery systems, that receive speech from a user or communicant and that provide voice responses.

In addition, embodiments of the present invention do not require that a communicant attribute be determined in a step that is separate from detecting a speech characteristic of a communicant. For example, a selection of a voice response set can be made after a speech characteristic has been detected from the detected speech characteristic where there is a one to one correspondence between the detected speech characteristic and an appropriate voice response set. In addition, the determination of a communicant attribute and thus an appropriate voice response set can be made after detecting a particular set of speech characteristics.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments with various modifications required by their particular application or use of the invention. It is intended that the appended claims be construed to include the alternative embodiments to the extent permitted by the prior art.

What is claimed is:

1. A method for tailoring responses to a communicant, comprising:
receiving a first speech sample from a communicant;
analyzing said speech sample to detect at least a first speech characteristic of said first speech sample; and
selecting a response set based on said at least a first detected speech characteristic.

2. The method of claim 1, further comprising:
recognizing a meaning of at least one of said first received speech sample and a second speech sample, wherein said meaning does not comprise said detected at least a first characteristics of said first speech sample; and
selecting a response to said communicant, wherein said response is selected from said selected response set.

3. The method of claim 1, wherein said step of selecting a response based on said detected speech characteristic comprises:
determining a communicant attribute from said at least a first detected speech characteristic; and
selecting a response set appropriate to said determined communicant attribute.

4. The method of claim 3, wherein said determined communicant attribute is at least one of a foreign accent, speech speed, native language other than the language of said speech sample, gender and age.

5. The method of claim 4, wherein said determined communicant attribute is accent, and said selected response set includes stored verbal responses comprising slow speech.

6. The method of claim 3, wherein said determined communicant attribute comprises a foreign accent, said method further comprising:
identifying a native language of said communicant, wherein said selected response set includes stored verbal responses in said identified native language.

7. The method of claim 1, wherein said detected speech characteristic is speech speed, and said selected response set includes verbal responses comprising slow speech

8. The method of claim 4, wherein said determined communicant attribute is a particular native language, wherein said selected response set includes stored verbal responses in said particular native language.

9. The method of claim 4, wherein said determined communicant attribute is a native language other than the language of said speech sample, wherein said selected response set includes stored verbal responses comprising slow speech.

10. The method of claim 4, wherein said determined communicant attribute is gender, and wherein said selected response set includes stored verbal responses of a selected gender.

11. The method of claim 4, wherein said determined communicant attribute is gender, said method further comprising:
identifying a gender of said communicant;
selecting a message set in response to said identified gender, wherein at least a first message from said selected message set is presented to said communicant.

12. The method of claim 4, wherein said determined communicant attribute is age, said method further comprising:
determining an age of said communicant, wherein said selected response set includes stored voice responses appropriate to said determined age of said communicant.

13. The method of claim 4, wherein said determined communicant attribute is age, said method further comprising:
determining an age of said communicant;
selecting a message set in response to said identified age, wherein at least a first message from said selected message set is presented to said communicant.

14. The method of claim 1, wherein said speech sample is received in realtime.

15. A computational component for performing a method, the method comprising:
analyzing a speech sample received from a communicant;
detecting at least a first characteristic of said speech sample to determine a communicant attribute; and
in response to said determined communicant attribute, providing a response to said communicant, wherein said response comprises at least one of said first characteristic detected in said speech sample, a message related to said first characteristic detected in said speech sample, a message related to said determined communicant attribute and a verbal response comprising a second characteristic.

16. The method of claim 15, wherein said first characteristic comprises at least one of a communicant accent and speech speed, and wherein said communicant attribute comprises at least one of a particular native language, gender and age.

17. The method of claim 15, wherein said response comprises a message related to said determined communicant attribute, said message further comprising a request for input from said communicant regarding a preferred language.

18. The method of claim 15, wherein said response comprises a message related to said determined communicant attribute, said message further comprising an advertisement.

19. The method of claim 15, wherein said response comprises a verbal response comprising a second characteristic.

20. The method of claim 19, wherein said first characteristic indicates that said communicant is not a fluent speaker of a selected language, and wherein said second characteristic comprises slow speech in said selected language.

21. The method of claim 15, wherein said computational component comprises a computer readable storage medium containing instructions for performing the method.

22. The method of claim 15, wherein said computational component comprises a logic circuit.

23. An interactive voice response system, comprising:
means for receiving at least a first speech sample from a communicant;
means for analyzing said first speech sample to determine at least a first characteristic of said speech sample;
means for storing a plurality of voice response sets; and
means for selecting a one of said plurality of voice response sets in response to said determined at least a first characteristic.

24. The system of claim 23, further comprising:
means for determining a communicant attribute from said determined at least a first characteristic, wherein said means for selecting operates in response to said determined communicant attribute.

25. The system of claim 23, wherein said plurality of voice response sets comprise a first voice response set having voice responses in a first language and a second voice response set having voice responses in a second language.

26. A voice response system, comprising:
data storage having stored thereon a speech characteristic determining application and a plurality of voice response sets;
a processor operable to run said speech characteristic determining application, wherein operation of said application results in selection of a one of said voice response sets; and
a communication interface operable to receive speech samples to provide said samples for analysis by said speech characteristic determining application, and to provide a response from a selected voice response set.

27. The system of claim 26, further comprising:
a natural language speech recognition application, operable to determine a content of a speech sample, wherein a response from said selected voice response set is selected based on said content, and wherein said content does not comprise a speech characteristic of said speech sample.

28. The system of claim 26, further comprising:
a speech transducer, wherein said response from said communication interface is output to said communicant.

29. The system of claim 28, wherein said transducer comprises a speaker.
